(19) United States
(12) Patent Application Publication
(10) Pub. No.: US 2014/0345974 A1
(43) Pub. Date: Nov. 27, 2014

(54) STOWABLE STEP SYSTEM

(71) Applicant: LIPPERT COMPONENTS, INC., Elkhart, IN (US)

(72) Inventors: Michael Warren NEBEL, Smith Center, KS (US); Bryan James Roth, Topeka, IN (US)

(21) Appl. No.: 14/264,201

(22) Filed: Apr. 29, 2014

Related U.S. Application Data
(60) Provisional application No. 61/816,878, filed on Apr. 29, 2013.

(51) Int. Cl. E06C 1/38; E06C 7/08

(52) U.S. Cl. CPC E06C 1/38; E06C 7/08
USPC 182/159

(57) ABSTRACT

A collapsible step assembly includes at least one step and a plurality of stringers pivotally connected to corresponding pivot points associated with the step. The step assembly may interface with a slide assembly configured to receive the step assembly in sliding engagement when collapsed. Alternatively, the step assembly may interface with a hinge and bracket assembly

### CROSS REFERENCE TO RELATED APPLICATION

This application claims the benefit of U.S. Provisional Patent Application No. 61/816,878, filed Apr. 29, 2013, and incorporates by reference the disclosure thereof in its entirety.

### BACKGROUND OF THE DISCLOSURE

The present disclosure is directed to stowable step systems as might be used with a recreational vehicle, travel trailer, or other vehicle or structure.

### SUMMARY OF THE DISCLOSURE

The present disclosure illustrates and describes illustrative embodiments of a stowable step system. The system includes a collapsible step assembly including one or more steps pivotally connected together by an arrangement of stringers.

A leg support assembly may be attached to or integrally formed with a step, for example, a lowermost step. Alternatively, the leg support assembly may be attached to the stringer arrangement, for example, near a lowermost step. One or more legs may be pivotally connected to the leg support assembly and operable between a stowed position and a deployed position. A biasing mechanism, for example, a spring, may be provided to bias the legs to or toward the deployed position. Feet may be connected to lower portions of the legs for engagement with the ground when the step system is deployed. A latching mechanism may be provided to secure the legs in the stowed position.

One or more interface members may be attached to a step, for example, an uppermost step. Alternatively, such interface member(s) may be attached to the stringer arrangement, for example, near an uppermost step.

The interface member(s) may be configured for interfacing with a slide mechanism. For example, the interface member(s) may include or be connected to a roller, a slide member, or the like. The roller or slide member may be configured for rolling or sliding engagement with a guide member. The guide member may be configured for mounting to a vehicle or other structure. Alternatively, the interface member(s) may be configured for interfacing with a folding mechanism. For example, the interface member(s) may include or be connected to a hinge. The hinge may further be connected to a bracket configured for attachment to a vehicle or other structure.

### BRIEF DESCRIPTION OF THE DRAWINGS

FIG. 1 is a front perspective view of an illustrative embodiment of a stowable step system including a step assembly having a plurality of steps and a plurality of stringers tying the together and a slide mechanism including a pair of opposing guide rails and brackets configured for attachment of the stowable step system to a vehicle or other structure, wherein the step assembly is in a deployed state;

FIG. 2 is a side view of the embodiment of FIG. 1, wherein the step sub-assembly is in a deployed state;

FIG. 3 is a rear perspective view of the embodiment of FIG. 1, wherein the step sub-assembly is in a deployed state;

FIG. 4 is a perspective view of the embodiment of FIG. 1, wherein the step sub-assembly is in a stowed state;

FIG. 5 is a rear cut-away perspective view of a steps interfacing with stringers and a step assembly interfacing with a slide assembly;

FIG. 6 is a front elevation view of a collapsible step assembly interfaced with a slide assembly in the stowed position;

FIG. 7 is an end view of a leg support channel;

FIG. 8 is a partial top view of a leg support channel;

FIG. 9 is a partial side view of a leg support channel;

FIG. 10 is a partial bottom view of a leg support channel;

FIG. 11 is a partial cut-away bottom view of a step;

FIG. 12 is a front elevation view of a collapsible step assembly interfaced with a hinge and bracket in the deployed position;

FIG. 13 is a detail view of a collapsible and adjustable leg attached to a step assembly;

FIG. 14 is a front perspective view of a collapsible step assembly interfaced with a hinge and bracket in the deployed position;

FIG. 15 is a side elevation view of a collapsible step assembly interfaced with a hinge and bracket in the deployed position;

FIG. 16 is a front elevation view of a collapsible step assembly interfaced with a hinge and bracket in the stowed position;

FIG. 17 is a detail view of a collapsible and adjustable leg and foot in the stowed and latched;

FIG. 18 is a side elevation view of a collapsible step assembly interfaced with a hinge and bracket in the stowed position; and

FIG. 19 is a front perspective view of a collapsible step assembly interfaced with a hinge and bracket in the stowed position.

### DETAILED DESCRIPTION OF THE DRAWINGS

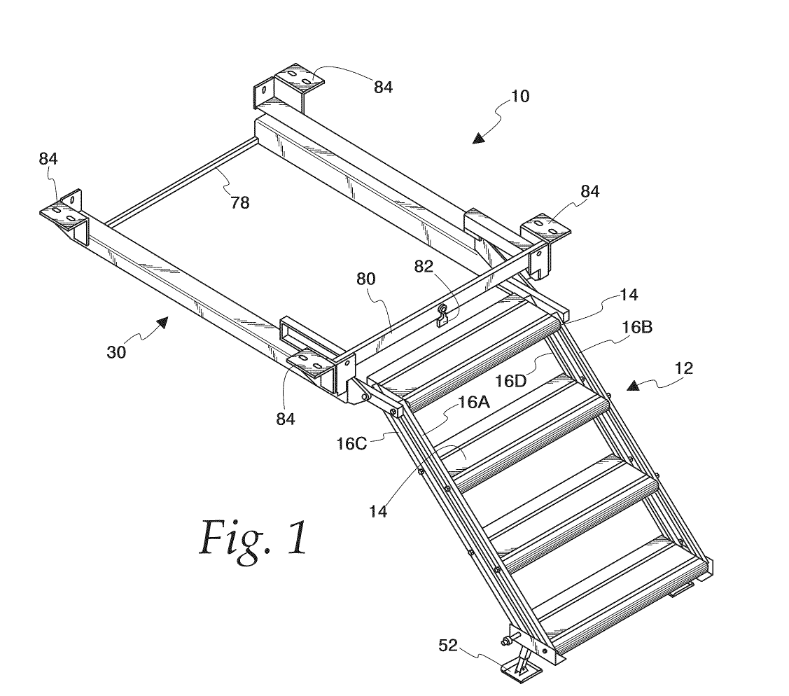

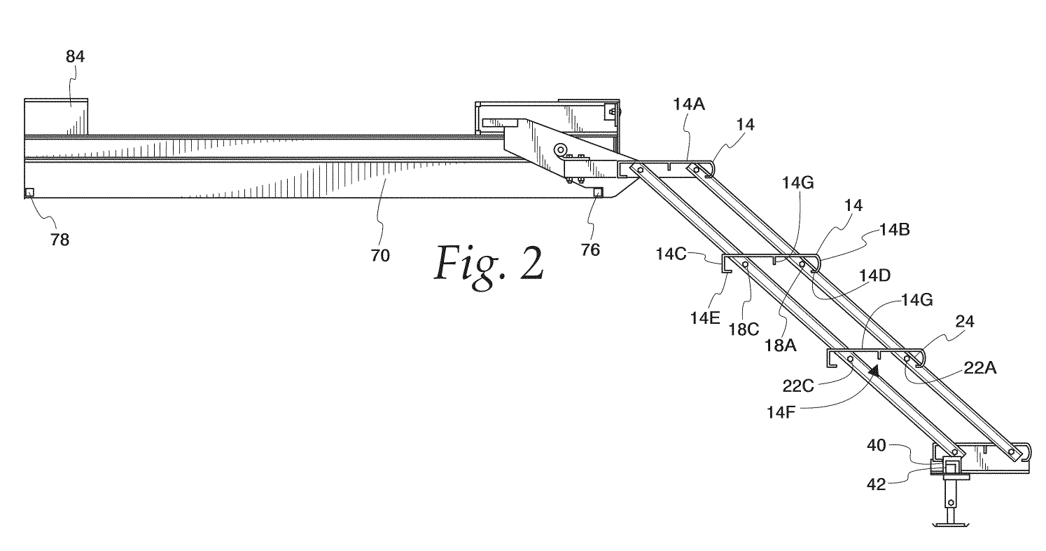

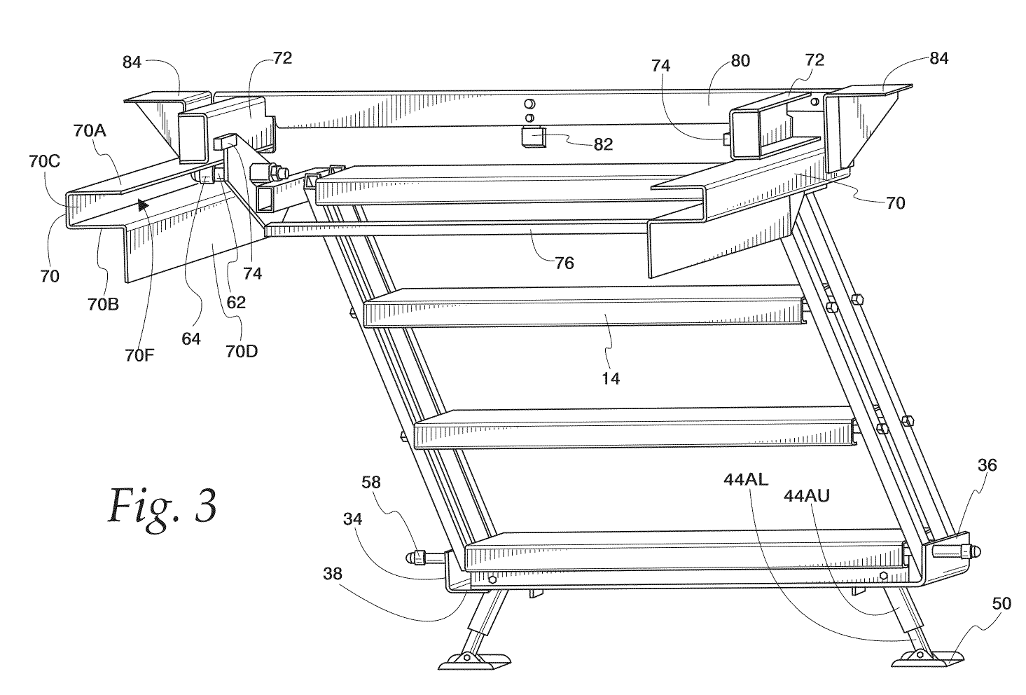

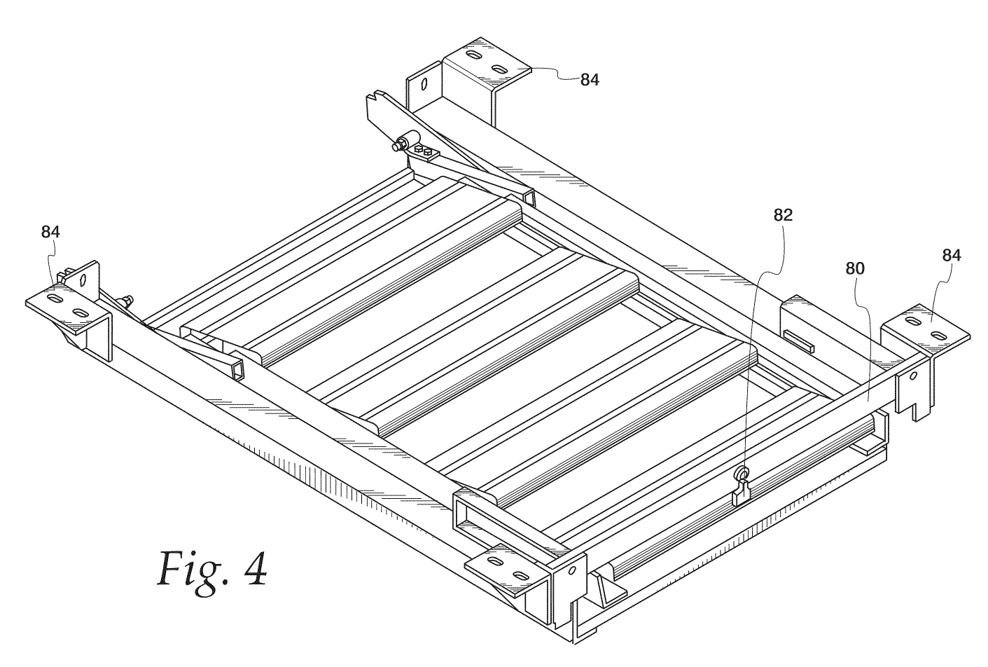

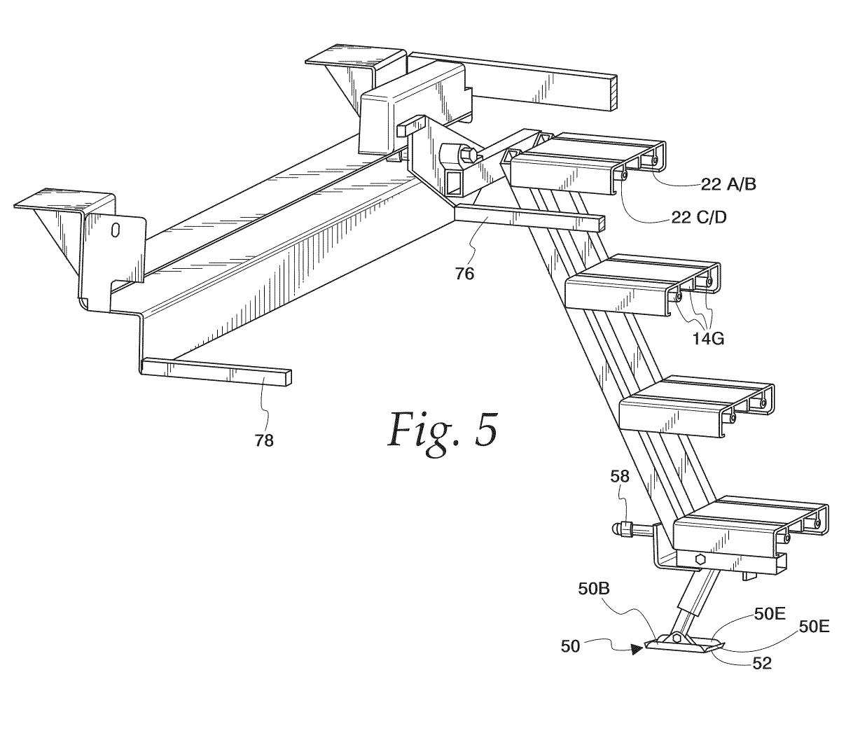

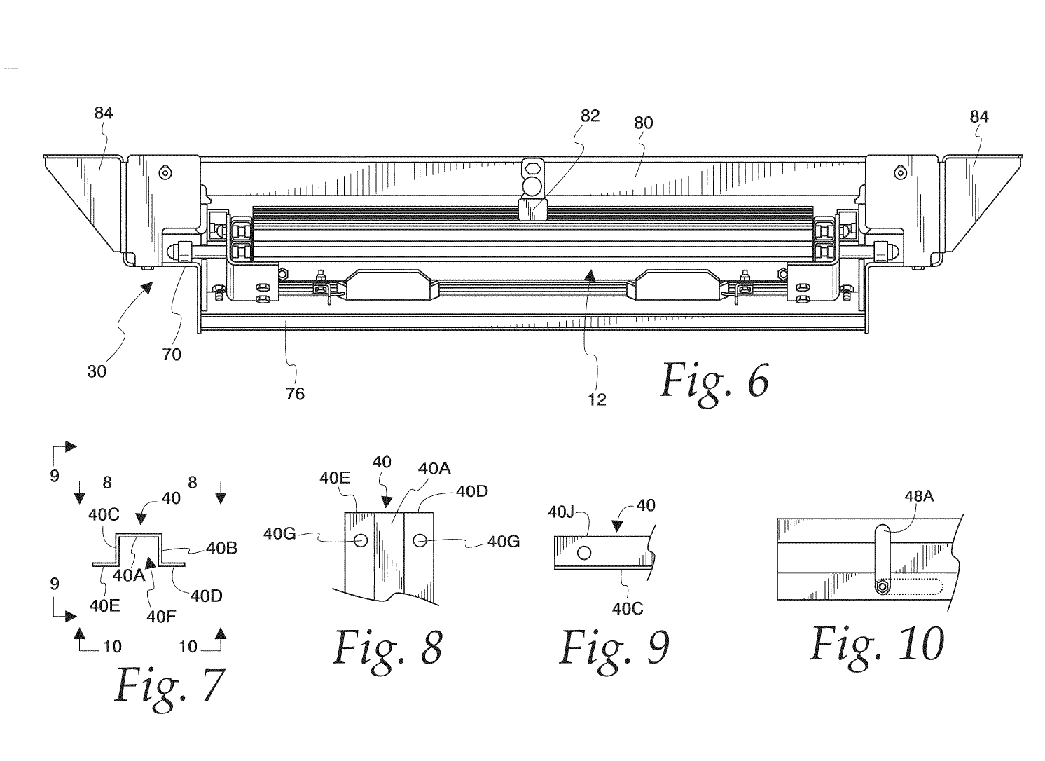

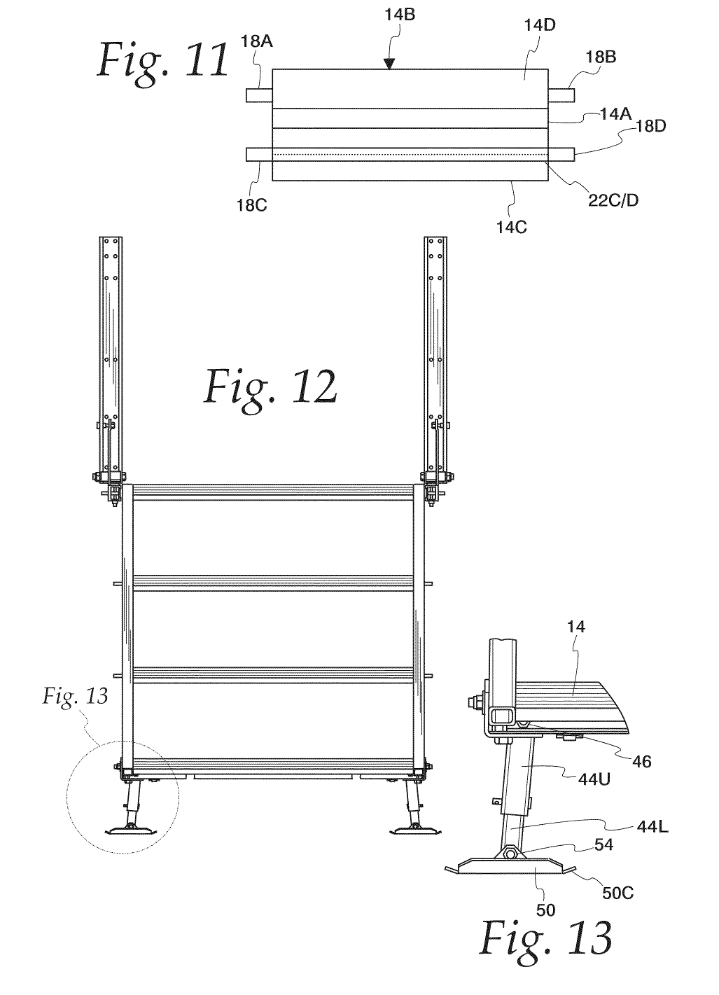

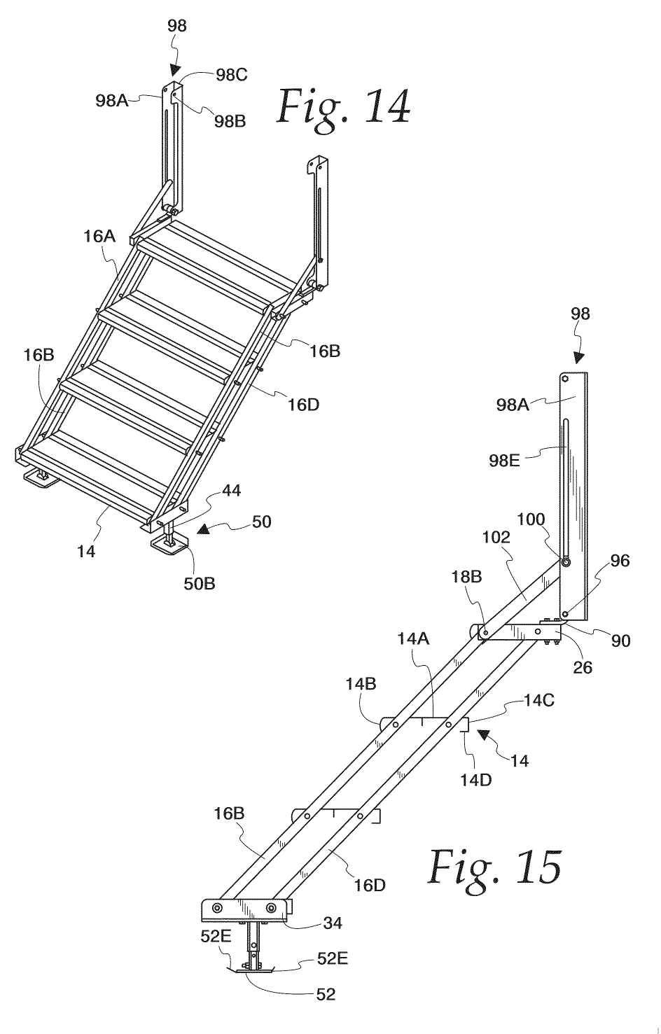

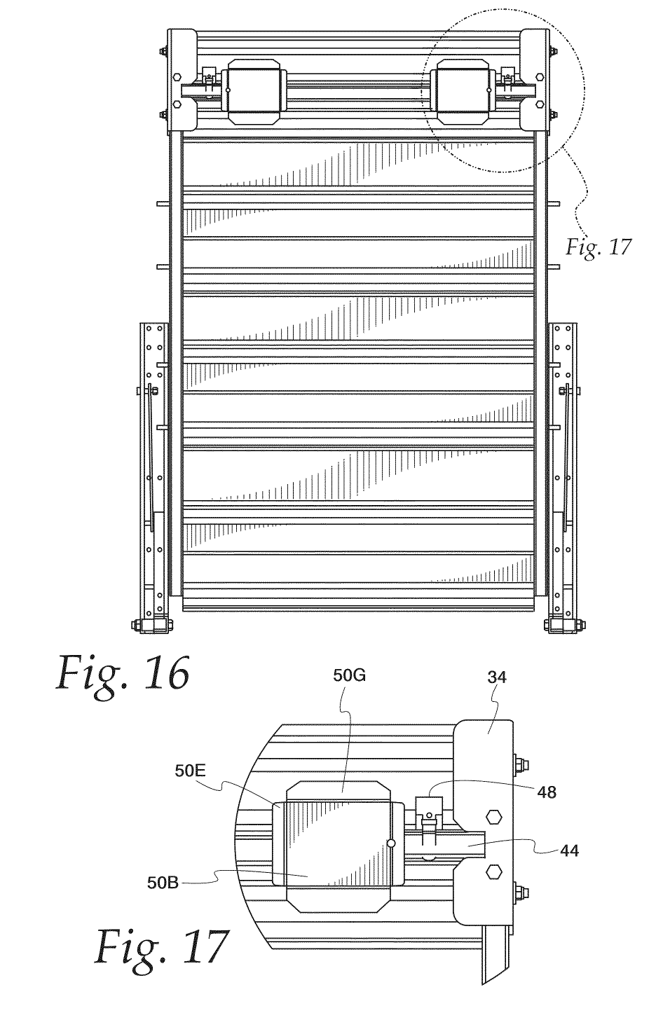

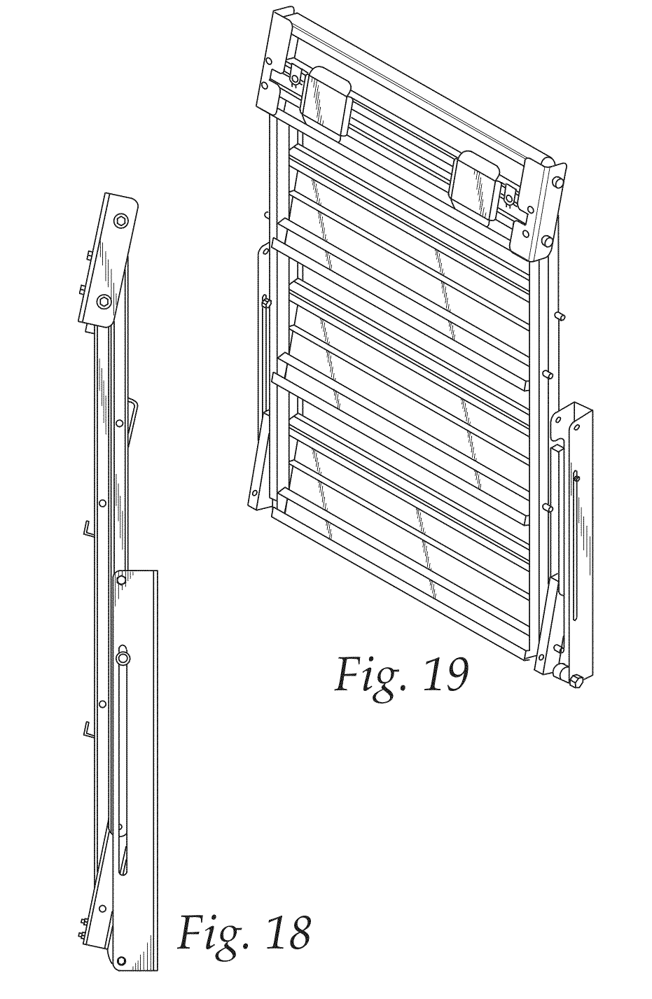

The drawings show embodiments of stowable step systems 10, 10′ in deployed and stowed positions. Stowable step systems 10, 10′ each include a generally identical collapsible step assembly 12. System 10 interfaces step assembly 12 with a slide assembly or mechanism 30 that may be attached to the underside of a vehicle or other structure, and system 10′ interfaces step assembly 12 with a hinge and bracket assembly that may be attached to a wall of a vehicle or other structure. FIGS. 1-6 show step assembly 12 interfaced with a slide assembly 30, and FIGS. 12, 14-16 and 18-19 show step assembly 12 interfaced with a hinge and bracket assembly. The remaining drawings show details of step assembly 12.

Step assembly 12 includes one or more steps 14 interconnected by a plurality of stringers 16A-16D. Four steps 14 are shown in the illustrative embodiment. Other embodiments could include more or fewer steps 14. Steps 14 may be made extruded or otherwise formed or made of aluminum, steel, or another suitable metallic or non-metallic material.

Each step 14 is shown as having a generally C-shaped cross-section including a tread portion 14A having a front (first) end, a rear (second) end, a left (third) end, and a right (fourth) end. Front and rear walls 14B, 14C depend, respectively, from front and rear ends of tread portion 14A. Front and rear returns 14D, 14E extend, respectively, from the ends of front and rear walls 14B, 14C opposite tread portion 14A. Tread portion 14A, first and second walls 14B, 14C, and first and second returns 14D, 14E cooperate to define an interior region 14F.

Three tread stiffeners 14G extend from tread portion 14A into interior region 14F. Other embodiments could include more or fewer than three tread stiffeners 14G. Tread stiffeners 14G are shown as extending generally the entire length of tread portion 14A, from the left end thereof to the right end thereof.

A first axle support 22A extends inwardly from about the left end of step 14 toward the right end thereof. A first axle 18A is retained by and extends outwardly from first axle support 22A, beyond the left end of step 14. A second axle support 22B extends inwardly from about the right end of step 14 toward the left end thereof. A second axle 18B is retained by and extends outwardly from second axle support 22B, beyond the right end of step 14. First and second axle supports 22A, 22B and first and second axles 18A, 18B are generally collinear and proximate the front end of step 14. A third axle support 22C extends inwardly from about the left end of step 14 toward the right end thereof. A third axle 18C is retained by and extends outwardly from third axle support 22C, beyond the left end of step 14. A fourth axle support 22D extends inwardly from about the right end of step 14 toward the left end thereof. A fourth axle 18D is retained by and extends outwardly from fourth axle support 22D, beyond the right end of step 14. Third and fourth axle supports 22C, 22D and third and fourth axles 18C, 18D are generally collinear and proximate the rear end of step 14.

First and second axle supports 22A, 22B are shown as a single boss associated with a first of tread stiffeners 14G proximate the front end of step 14. This boss is connected to the free end of the first of the tread stiffeners 14G opposite tread portion 14A, and extends from the left end of step 14 to the right end thereof. Third and fourth axle supports 22C, 22D are embodied in a similar manner and are associated with the second of the tread stiffeners 14G. Alternatively, any of axle supports 22A-22D could be embodied as a separate or individual boss or any other structure capable of supporting its corresponding axle 18A-18D. For example, axle supports 22A-22D could be embodied as individual bosses connected directly to step 14 without connection to an intervening stiffener. In another embodiment, step 14 could be embodied as a plank defining axle supports 22A-22D in the form of bores extending inwardly from the left and right ends thereof, the bores being configured for receiving and retaining axles 18A-18D.

Step assembly 12 also includes four stringers 16A-16D configured for pivotal engagement with steps 14 by way of axles 18A-18D. A first stringer 16A defines apertures configured to receive axles 18A of each of corresponding steps 14. A second stringer 16B defines apertures configured to receive axles 18B of each of corresponding steps 14. A third stringer 16C defines apertures configured to receive axles 18C of each of corresponding steps 14. A fourth stringer 16D defines apertures configured to receive axles 18D of each of corresponding steps 14. The foregoing apertures in stringers are shown inherently, if not expressly. Stringers 16A-16D and treads 14 cooperate in a parallelogram arrangement so that steps 14 remain generally parallel to each as stringers 16A-16D and steps 14 move with respect to each other.

Stringers 16A-16D are shown as elongated structural box members. In other embodiments, stringers 16A-16D could take other forms. For example, stringers 16A-16D could be embodied as strips, angles, or structural members of other shapes.

Axles 18A-18D may include, incorporate, or cooperate with any suitable variety of fastener to connect axles 18A-18D to stringers 16A-16D. For example, axles 18A-18D could be internally or externally threaded and configured to receive corresponding mating fasteners to thereby secure axles 18A-18D to stringers 16A-16D in pivotal engagement. Washers, bushings, bearings and the like could be provided at the axle/stringer interfaces to improve the quality of the connections there.

A leg assembly 32 is attached to a lower portion of step assembly 12. Leg assembly 32 is shown as including first and second leg support bracket 34. The first leg support bracket 34 is connected to axles 18A, 18C of the lowermost tread 14, preferably, outboard of stringers 16A, 16C. The second leg support bracket 34 is similarly connected to axles 18B, 18D of the lowermost tread 14. Alternatively, leg support brackets 34 could be pivotally attached to the corresponding stringers 16A-16D via further axles or pins (not shown) connected to the stringers, and not necessarily to any step 14.

Each leg support bracket 34 is shown as a structural angle having a first flange 36 generally parallel to stringers 16A-16D and a second flange 38 generally perpendicular thereto. Second flanges 38 are shown as extending inwardly or toward each other. In other embodiments, second flanges 38 could extend outwardly, away from each other.

A leg support channel 40 extends between, and is connected to, first and second leg support brackets 34. Leg support channel 40 is shown as a generally U-shaped channel having first and second generally parallel flanges 40A, 40B joined at one end by a web 40C that is generally perpendicular to both of first and second flanges 40B, 40C. First and second flanges 40B, 40C cooperate with web 40A to define an interior region 40F of leg support channel 40. A first stiffener 40D extends outwardly from the free end of first flange 40B, generally parallel to web 40A. A second stiffener 40E extends outwardly from second flange 40C in a similar manner. Each of stiffeners 40D, 40E defines a first aperture 40G at a first end thereof and a second aperture 40H at a second end thereof. Corresponding apertures are provided in first and second leg support brackets, respectively. Fasteners 42 extending through apertures 40G, 40H of leg support channel 40 and the corresponding apertures in leg support brackets 34 secure leg support channel 40 to leg support brackets 34. Alternatively, leg support channel 40 could be connected to first and second leg brackets 34A, 34B by other means, for example, welding, bonding, or the like. As a further alternative, leg support channel 40 and leg support brackets 34 could be integrally formed, for example, by molding.

First and second flanges 40A, 40B of leg support channel 40 define a first pair of corresponding apertures 40J near the first end thereof and configured to receive an axle or pin 46. First and second flanges 40B, 40C of leg support channel 40 similarly define a second pair of corresponding apertures 40J near the second end thereof. A first leg 44 is pivotally connected to leg support channel 40 by means of a first leg axle 46 pivotally engaged with the first pair of apertures 40J in leg support channel and a corresponding aperture or apertures in the first leg 44. A substantial portion of the first leg 44 may nest within the interior region 40F of leg support channel 40 when the first leg 44 is in the stowed position. A second leg 44 may be similarly connected to leg support channel 40 by means of a second leg axle 46 pivotally engaged with the second pair of apertures 40J in leg support channel 40 and a corresponding aperture or apertures in the second leg 44.

A torsion spring or other form of spring or biasing element may be provided at each leg/leg support channel connection to bias legs 44 to or toward deployed positions, as will be discussed further below. Latches 48 may be provided to secure legs 44 in the stowed position. Each latch 48 may be embodied as member rotatably attached to either of stiffeners 40D, 40E and rotatable between a first position generally parallel to and overlying the stiffener and a second position generally perpendicular to the stiffener and extending to or toward the opposing stiffener. In the second position, first latch 48A could overlie a portion of the opposing stiffener.

Each leg 44 is shown as a telescopically-extendable structure including an upper leg portion 44U and a lower leg portion 44L in telescopic, sliding engagement with upper leg portion 44U. Upper leg portion 44U and lower leg portion 44L are shown as tubular structures having a square cross-section, with lower leg portion 44L telescopically engaged with upper leg portion 44U.

Each of upper leg portion 44U and lower leg portion 44L are provided with one or more apertures extending partially or completely therethrough. Respective apertures of upper leg portion 44U and lower leg portion 44L may be selectively aligned to receive a pin 50 therethrough, thereby securing upper leg portion 44U to lower leg portion 44L. The foregoing apertures may be aligned and pinned in various configurations to thereby selectively set the length of each leg 44 at one of several predetermined lengths.

A foot 52 is attached to lower leg portion 44L via a pinned connection. Foot 52 includes a generally planar and square base 52B and four ears 52E extending therefrom. Ears 52E may extend at an angle upwardly with respect to base 52B. As such, ears 52E may resist embedding of base 50B into soil or another ground surface upon which the foot 50 may be placed. A U-shaped bracket 76 having a base 76B and two sidewalls 76S is attached to base 76B. Base 76B of bracket 76 may be welded or otherwise attached to base 74B of foot 74. Side walls 76S extend upwardly from base of bracket. Side walls 76S define apertures 76A which are aligned along an axis perpendicular to sidewalls 76S. The lower end of lower leg portion 44L may be received between sidewalls 76S with apertures 68A, 70A of lower leg portion 44AL aligned with apertures 76A. So aligned, a clevis pin 78 or other suitable pin structure may be inserted through the foregoing apertures to thereby rotatably pin foot 74 to lower leg portion 44L. Like clevis pins 66 and 72, clevis pin 78 may be configured to receive a cotter pin to preclude inadvertent disengagement of clevis pin 78 from the foregoing apertures.

A guide or support member 58 extends from each of the left and right sides of step assembly 12 near the lowermost tread thereof. Each such guide member 50 may be coextensive or simply collinear with one of axles 18A-18D or another axle or pin (not shown) extending outwardly from one of stringers 16A-16D or leg support brackets 34A, 34B or otherwise attached to step assembly 12. Guide members 58 may be embodied as rollers, support blocks, or any suitable structures configured to be received by a guide rail 70 of slide mechanism 30, as will be discussed further below.

A first interface arm 26 is pivotally connected to axles 18A, 18C of an uppermost tread 14, outboard of stringers 16A, 16C. Alternatively, first interface arm 26A may be pivotally connected to other axles (not shown) connected to stringers 16A, 16C instead of to axles 18A, 18C. A second interface arm 26 is connected to axles 18B, 18D of the uppermost tread 14 (or to other axles connected to stringers 16B, 16D instead of to axles 18B, 18D) in a similar manner

It should be apparent that axles 18n may of various lengths and configuration as necessary to facilitate connection to stringers 16n, leg support brackets 34A, 34B and interface arms 26A, 26B, as discussed above.

A first latch arm 60 is connected to first interface arm 26, and a second latch arm 60 is connected to second interface arm 26. A roller pin 62 is connected to and extends outwardly from each latch arm 60. A roller 64 is rotatably connected to each roller pin 62. Rollers 64 are configured to be received by corresponding guide rails 70 in rotating and or sliding engagement, as discussed further below. One or both of latch arms 60 defines a first notch 66 near a rear and upper portion thereof. First notch 66 is configured in a manner complementary to a corresponding upper latch member 74, as will be discussed further below. One or both of latch arms 60 also defines a second notch 68 near a rear and lower portion thereof. Second notch 68 is configured in a manner complementary to a lower latch member 76, as will be discussed further below.

Slide assembly 30 includes first and second guide rails 70 that may be mirror images of each other. Each guide rail 70 is shown as a generally C-shaped channel having a first flange 70A, a second flange 70B, and a web 70C connecting the first flange to the second flange at ends thereof. First and second flanges 70A, 70B are generally parallel to each other, and web 70C is generally perpendicular to first and second flanges 70A, 70B. First flange 70A, second flange 70B, and web 70C cooperate to define an interior region 70F. Interior region 70F is sized and configured to rollingly and/or slidingly receive the corresponding roller 64 attached to the corresponding latch arm 60. A stiffener 70D extends outwardly from the free edge of second flange 70B.

A latch mount 72 is connected to an upper portion of one or both guide rails 70, for example, to first flange 70A thereof. Latch mount 72 is shown as a C-shaped channel having a stiffener substantially closing one otherwise open end thereof. A latch member 74 extends inwardly from latch mount 72 toward the opposing guide rail 70. Latch member 74 is shown as a rectangular member attached to latch mount 72. Latch member 74 is configured to be engaged by complementarily-shaped upper notch 66 of corresponding latch arm 60 when step assembly 12 is deployed.

A front crossbar 76 extends from stiffener 70E of one of guide rails 70 to stiffener 70E of the other of guide rails 70 proximate first or front ends thereof. Front crossbar 76 is shown as a square tube or bar but could be configured in other manners. Front crossbar 76 is configured to be engaged by complementarily-shaped lower notch 68 of latch arms 60 when step assembly 12 is deployed. As such, front crossbar 76 can function as a latch member.

A rear crossbar 78 extends from stiffener 70E of one of guide rails 70 to stiffener 70E of the other of guide rails 70 proximate second or rear ends thereof. Rear crossbar 78 may be configured in manner similar to front crossbar 76. Rear crossbar 78 is configured to be engaged by complementarily-shaped lower notch 68 of latch arms 60 when step assembly 12 is stowed. As such, rear crossbar 78 functions as a stop member to prevent overtravel of step assembly 12 with respect to slide mechanism 30 when step assembly 12 is transitioned from the deployed position to the stowed position.

A lock mount 80 extends between first and second guide rails 70 at the first ends thereof. A locking tab 82 is pivotally connected to lock mount 80. Locking tab 82 can be rotated between a first position in which locking tab 82 precludes step assembly 12 from extending from slide rails 70 and a second position in which locking tab 82 permits step assembly 12 to extend from guide rails 70.

In use, with step assembly 12 initially stowed in the slide mechanism and locking tab 82 in the first position, locking tab 82 may be moved to the second position, thereby allowing step assembly 12 to be withdrawn from slide assembly 30. Step assembly 12 may be withdrawn, for example, by pulling on any accessible portion thereof, for example, the lowermost step 14. The accessible portion of step assembly may also be lifted to elevate guide/support 58 from contact with guide rails 30. Rollers 64 provide support for the upper portion of step assembly with respect to guide rails 60.

With step assembly 12 withdrawn a suitable distance from slide assembly 30, if at all, legs 44 can be unlatched and allowed to deploy to their deployed positions. The biasing mechanism, if provided, may bias legs 44 toward their deployed positions.

Once step assembly 12 has been fully withdrawn and legs 44 have been deployed, the lower end of step assembly 12 may be lowered toward the ground until feet 52 contact the ground. As the lower end of step assembly 12 is initially lowered toward the ground, latch arms 60 rotate about roller axle 62 until upper notches 66 of latch arms 60 engage with corresponding upper latch members 74 and lower notch 68 of latch arm 60 engage with front crossbars 76, thereby precluding further rotation of latch arm 60 with respect to slide mechanism (and corresponding rotation of interface member 26), and inadvertent translation of latch arm 60 into slide assembly 30.

As step assembly is lowered further, stringers 16A-16D rotate about their connections to interface arm 26 and about their connections to steps 14. Steps 14 remain parallel to each other. The length of legs 44 can be set independently so that steps 14 are generally parallel to the ground upon which feet 52 rest.

Stowing is the reverse of deployment. The lower end of step assembly may be raised so that stringers 16A-16D rotate about their connections to steps 14 and to interface arms 25, typically until pairs of stringers on each of steps 14 come into contact with each other. Once stringers come into contact with each other, further raising of the lower end of step assembly 12 causes latch arm 60 to rotate about roller axle 62. This causes upper and lower notches 66, 68 of latch arm 60 to disengage from upper and lower latch members 74, 76, respectively. With latch arm 60 disengaged from latch members 74, 76, step assembly 12 may be pushed into slide assembly 30 until lower notches 68 of latch arms 60 engage with rear crossbar 78. Once step assembly 12 has been fully inserted into slide assembly 30, locking tab 82 can be rotated to the lock position to preclude inadvertent release of step assembly 12 from slide assembly 30.

Slide assembly 30 may be mounted via a suitable bracket arrangement to the underside of a recreational vehicle, trailer, or other structure. Slide assembly 30 could be attached to the bottom of a slide out room provided with such a vehicle or structure.

As suggested above, system 10′ is similar to system 10, except that step assembly 12 interfaces with a hinge and bracket assembly instead of slide assembly 30. As shown, for example, in FIGS. 12, 14-16, and 18-19, interface arms 26 of system 10′ interfaces with hinge brackets 90. Each hinge bracket 90 includes a planar portion configured for attachment to interface arm 26 by means of fasteners 92, welding, or other suitable means. Hinge bracket 90 also includes an axle-receiving boss 94 offset from the planar portion thereof.

A wall bracket 98 is pivotally connected to axle-receiving boss 94 by means of an axle 96. Wall bracket 98 is shown as a generally U-shaped member having first and second flanges 98A, 98B joined by a web 90C. Web 98C may define apertures for receiving fasteners configured to retain wall bracket 98 to a wall of a vehicle or other structure.

First flange 98A defines a slot 98E configured to receive a pin 100 in sliding engagement therewith. Pin 100 is connected to a first end of a support arm 102. A second end of support arm 102 is pivotally connected to step assembly 12, for example, to axle pin 18B of an uppermost step 14 thereof. Slot 98E, support arm 102, and the connection of support arm 102 to step assembly 12 cooperate to limit the rotation of step assembly 12 with respect to wall bracket 98. A portion of second flange 98B may define a recess providing clearance for support arm 102, pin 100, interface arm 26, and or other portions of step assembly 12 when step assembly is in the stowed position.

A latch may be provided to secure step assembly 12 to wall brackets 98 or a wall to which system 10′ may be attached when in the stowed position.

In use, with step assembly 12 initially collapsed and folded up against wall brackets 98, step assembly 12 may be deployed by unlatching the latch and rotating step assembly 12 about axle 96, away from wall brackets 98. As step assembly 12 is thus lowered, interface member 26 rotates about axle 96. As interface member 26 rotates, it draws support arm 102 with it, thus causing pin 100 to slide from an upper portion of slot 98E to a lowest portion of slot 98E, such that support arm 102 moves from a first position generally parallel to wall brackets 98 to a second position wherein support arm 102 is triangulated with wall bracket 98 and interface arm 26. In the second position, support arm 102 precludes further rotation of interface arm 26 about axle 96. With further rotation of interface arm 26 thus halted, further lowering of step assembly 12 causes step assembly to unfold as discussed in connection with system 10.

Stowing is the reverse of deploying. The lower end of step assembly may be raised, causing step assembly to collapse as discussed in connection with system 10. With step assembly 12 collapsed, further elevation of the lower portion of step assembly 12 causes step assembly to rotate abut axle 96 until step assembly 12 is generally vertical and against wall brackets 98. Step assembly 12 can then be latched to wall brackets 98 or the wall to which they are attached.

1. A stowable step system, comprising:
a collapsible step sub-assembly, the sub-assembly comprising:
at least one step, each said at least one step having a first end, a second end opposite said first end, a third end, and a fourth end opposite said third end;
a first axle pin extending from said first end proximate said third end,
a second axle pin extending from said first end proximate said fourth end,
a third axle pin extending from said second end proximate said third side,
a fourth axle pin extending from said second end proximate said fourth end,
a first stringer rotatably engaged with corresponding ones of said first axle pins,
a second stringer rotatably engaged with corresponding ones of said second axle pins,
a third stringer rotatably engaged with corresponding ones of said third axle pins,
a fourth stringer rotatably engaged with corresponding ones of said fourth axle pins,
a first interface member rotatably engaged with upper portions of said first and second stringers,
a second interface member rotatably engaged with upper portions of said third and fourth stringers; and
a leg assembly associated with a lower portion of one or more of said first, second, third and fourth stringers.

2. The step system of claim 1 wherein said leg assembly is rotatably connected to said axle pins of a lowermost of said steps, said leg assembly including a plurality of legs pivotally connected to a leg support and pivotable between first and second positions.

3. The system of claim 1 further comprising a slide assembly connected to said step assembly, said slide assembly comprising a first latch arm connected to said first interface member and a second latch arm connected to said second interface member, each of said latch arms comprising a guide member;
said slide assembly further comprising a first guide rail configured to receive said guide member of said first latch arm in rolling or sliding engagement and a second guide rail configured to receive said guide member of said second latch arm in rolling or sliding engagement.

4. The system of claim 3 wherein said guide member is a roller.

5. The system of claim 3 further comprising a first latch member associated with said first guide rail, wherein said first latch arm defines a first notch configured for selective engagement with said first latch member.

6. The system of claim 5 further comprising a second latch member associated with said first guide rail, wherein said first latch arm defines a second notch configured for selective engagement with said second latch member.

7. The system of claim 6 further comprising a stop member associated with said first guide rail, wherein said second notch is configured for selective engagement with said stop member.

8. The system of claim 5 further comprising a second latch member associated with said first guide rail, wherein said first notch is configured for selective engagement with said second latch member.

9. The system of claim 1 wherein said interface members are rotatably engaged with corresponding ones of said axle pins.

10. The system of claim 1 wherein said leg assembly is rotatably engaged with corresponding ones of said axle pins.

11. The system of claim 1 further comprising a first bracket hingedly connected to said first interface member and a second bracket hingedly connected to said second interface member.

12. The system of claim 11 further comprising a first pivot arm pivotally to said first interface member and slidingly connected to said first bracket.
